(19) United States
(12) Patent Application Publication
(10) Pub. No.: US 2004/0232691 A1
(43) Pub. Date: Nov. 25, 2004

(54) Document and method against counterfeiting and forgery of the same

(76) Inventor: Maurizio Lazzerini, Bollate (IT)

Correspondence Address: COHEN, PONTANI, LIEBERMAN & PAVANE, 551 FIFTH AVENUE, SUITE 1210, NEW YORK, NY, 10176, US

(21) Appl. No.: 10/489,149

(22) PCT Filed: Aug. 1, 2002
(86) PCT No.: PCT/EP02/08592

(30) Foreign Application Priority Data
Sep. 10, 2001 (IT) MI2001A001889
Oct. 17, 2001 (EP) 01124814.3

(51) Int. Cl. B42D 15/00

(52) U.S. Cl. 283/67

(57) ABSTRACT

A method for customising security documents, particularly banknote, checks and documents representing a value in general. The method is suitable to prevent their forgery and alteration and comprises the steps that consist in superimposing at least two materials (10, 20) having different resistances to laser and being arranged adjacent to each other onto a substrate (30) having a higher resistance to laser than each of the superimposed materials (10, 20) and treating said superimposed materials (10, 20) with a laser beam which is guided along a preset path in order to modify by sublimation a part of each superimposed material (10, 20) by subjecting it to said laser beam without substantially burning or sublimating said substrate (30).

The present invention relates to a method for the customization of security documents and optionally their numbering, particularly banknotes, checks and documents in general that represent a value, but also identity documents, passports, cards, tickets, security labels or anything else requiring guarantees against forgery.

Any document that represents value, particularly banknotes and checks, requires particular measures that are aimed specifically at preventing its counterfeiting and forgery by ill-intentioned individuals.

The problem is particularly felt in relation to the counterfeiting of banknotes, for which an ever-higher level of security is required; necessarily, said banknotes must be produced with solutions suitable to make them difficult to reproduce and alter. Nowadays, every banknote has characteristic elements, such as watermarked paper that displays symbols or figures imprinted so that they are visible only if held up to the light, a silver-coated thread that is usually arranged vertically, holograms and so forth. Each banknote is furthermore characterized by its own serial number.

The production of counterfeit banknotes requires knowledge of the process and of the exact chemical and physical elements used by the national mint. Although such production is certainly not easy to implement, the difficulty of the operation is nonetheless insufficient to deter all counterfeiters.

Moreover, the situation of forgery or alteration of an original banknote produced with a known method is much more severe. It is in fact relatively simple to alter the serial number of a banknote, and this operation is usually performed to facilitate money laundering.

The same problems apply to all value-bearing documents, such as checks, identity documents, tickets and so forth, which are identified by an individual number or code. Even if complete duplication is inconvenient for the counterfeiter, it is in fact never difficult enough to fall back on the alteration of original documents, which makes it virtually impossible to distinguish a forged document from an original one.

Document U.S. Pat. No. 6,082,778 A discloses an identity card or similar data carrier having a metal layer which serves as a copy protection element. The card is inscribed with a laser beam so that markings continue from the copy protection element into the card.

The aim of the present invention is to overcome the above described limitations, illustrating a method that allows to improve the current level of security applied to value-bearing documents.

Within the scope of this aim, an object of the present invention is to make it extremely difficult not only to produce counterfeits but also to forge a valid document.

Another object of the present invention is to allow easier and certain identification of a forged document.

Another object of the present invention is to provide a method for treating value-bearing documents that is simple to provide and modest in cost.

This aim, these objects and others that will be become apparent hereinafter are achieved by a method against counterfeiting and forgery of documents particularly banknote and documents representing money, comprising the steps that consist in: superimposing at least two materials having different resistances to laser and being arranged adjacent to each other onto a substrate having a higher resistance to laser than each of the superimposed materials; treating said superimposed materials with a laser beam which is guided along a preset path in order to modify by sublimation a part of each superimposed material by subjecting it to said laser beam without substantially burning or sublimating said substrate.

The aim, the objects and others are also be achieved by a document numbered or customized against forgery and counterfeiting particularly a banknote or a document representing money, comprising: at least two materials having different resistances to laser, being arranged adjacent to each other and being superimposed onto a substrate having a higher resistance to laser than each of the superimposed materials; said superimposed materials are treated with a laser beam along a preset path, wherein a part of each superimposed material subjected to said laser beam is sublimated and said substrate is substantially not burned or sublimated by said laser beam, so as to form a scribing in the superimposed materials.

In another aspect of the invention, a method against counterfeiting and forgery of documents particularly banknote and documents representing money comprises the steps that consist in: coupling at least two materials with a different resistance to laser; treating with a laser beam at least two of said materials in order to modify by burning or sublimating part of at least one of said coupled materials by subjecting it to said laser beam, which is guided along a preset path.

Coupling can be provided by arranging the materials in positions that are partially or totally adjacent or superimposed or in a combination of said positions.

Advantageously, the energy of the laser beam remains substantially constant during the scribing of the materials by sublimation or burning, the amount of removed material depending on the resistance to laser of said materials.

Conveniently, the movement of the laser beam along the preset path scribes the materials that it encounters, forming an alphanumeric symbol or a graphic symbol.

Another aspect of the invention is a document numbered or customised against forgery and counterfeiting comprising a plurality of materials that are partially or fully coupled to each other and have different resistances to laser and at least one of said materials bears scribing produced by means of a laser beam.

Further characteristics and advantages of the present invention will become apparent from the following detailed description, given by way of non-limitative example and illustrated in the accompanying figures, wherein:

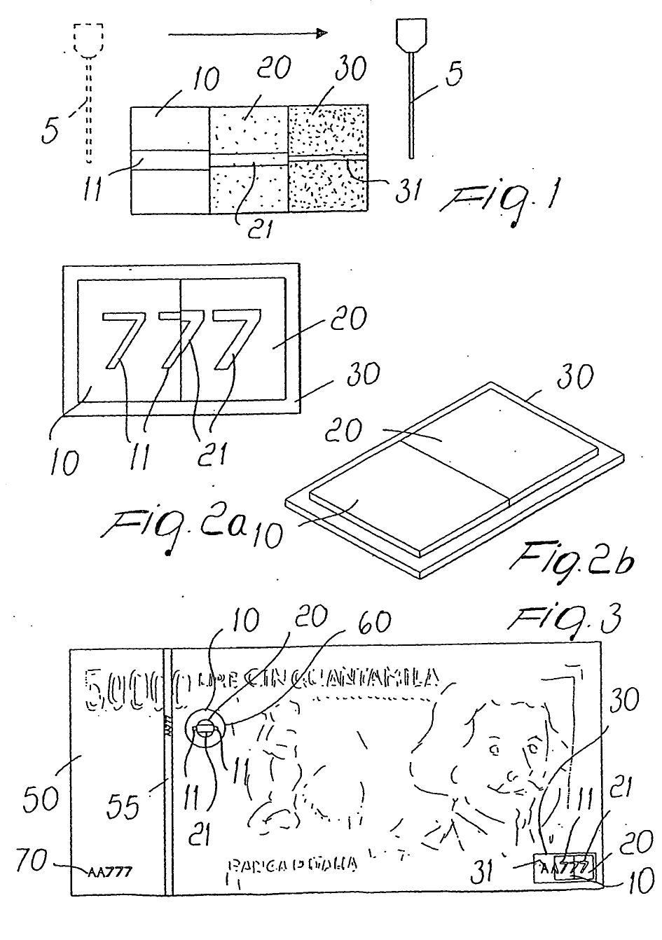

FIG. 1 is a schematic view of the line left by a laser beam with substantially constant energy, moved along a straight line that intersects three materials 10, 20, 30 having different resistance and arranged mutually adjacent;

FIG. 2 is a schematic view of the line left by a laser beam moved along a path that is suitable to form an alphanumeric string and intersects two materials having different resistance arranged adjacent to each other and superimposed on a third material that has a greater resistance than the first two;

FIG. 3 is a view of a banknote provided with a serial number, a silver coated thread and a logo produced according to an embodiment of the teachings of the inventive method according to the present invention.

FIG. 1 illustrates the line left by a laser beam 5 emitted at substantially constant energy and moved along a straight path that intersects three materials 10, 20, 30 having different resistance to laser and arranged adjacent to each other.

The laser allows to remove, displace or modify optically, chemically and physically the materials encountered along its path of motion, scribing the treated material, particularly by sublimation or burning of the par exposed to the beam.

The laser used can be of any kind according to the requirements and the materials that are treated. Merely by way of example, the present description refers to a laser of the YAG (Yttrium Aluminium Garnet) type having the following characteristics:

| | |
|---|---|
| Wavelength λ: | between 1060 and 1070 nm, |
| | preferably 1061 nm; |
| Beam quality factor: | <1.1 (SM); |
| Spot diameter: | substantially 40 μm; |
| Depth of focus: | ±0.3 mm; |
| Positioning speed: | substantially 20 m/s; |
| Nonlinearity: | <=0.05%; |
| Zero drift: | substantially 4 μm/° C.; |
| Gain drift: | −60 ppm/° C. |

The laser apparatus can be provided by means of a scanning head located remotely with respect to the laser source by means of a flexible optical fiber with an average length of 5 meters, so as to allow to mount multiple scanning heads side by side while maintaining the possibility to use each laser independently. The emission of the laser beam 5 is preferably continuous and not pulsed, so as to have graphic lines and markings entirely without discontinuities. Finally, due to cost-related reasons, the cooling of the system is preferably performed by forced air, so as to minimize the maintenance required.

With reference to FIGS. 1 and 2, the operation of the method according to the present invention is as follows.

Multiple materials 10, 20, 30 having different resistance are arranged in adjacent or superimposed positions or in a combination of these two positions and are subjected to a laser beam emitted with substantially constant energy.

The laser beam is absorbed differently according to the material that is treated. The same laser beam, projected onto materials having different resistance, accordingly produces scribing of different extents. More specifically, one obtains a variation in the width of the line 11, 21, 31 that is scribed by sublimation or burning, owing to the different absorption of energy on the part of the respective materials 10, 20, 30. It is noted that the extent of the scribing is inversely proportional to the resistance of the material. For example, the three materials 10, 20, 30 shown schematically in FIG. 1 have increasing resistances. The material 10 has the lowest resistance, the material 20 has a higher resistance than the material 10, and the material 30 has a higher resistance than both. The line 11 produced in the material 10 is therefore thicker than the line 21 produced by the same laser beam 5 in the material 20, and the line 21 is in turn thicker than the line 31 produced in the material 30.

With reference now to FIG. 2, a particularly advantageous configuration is achieved by arranging adjacent to each other two materials 10, 20 having different resistances and by superimposing them on a third material with high resistance to laser, which acts as a substrate for the first two. By moving the laser head along a preset path so as to scribe the materials 10 and 20, one obtains a variation of the scribed line that is the result of the energy absorption caused by the difference of the materials involved. In particular, by composing a product having multiple layers from bottom to top with materials that are progressively more resistant, one obtains a line with well-defined contours that is perfectly in register and whose width variation remains a function of the absorbed energy.

In this manner, it becomes possible to obtain unique graphic markings that are linked univocally to the substrate and depend on registration precision, which is different according to the various known printing or deposition methods used to deposit the materials and according to the characteristics of the materials themselves.

The aim of the invention is perfectly achieved when at least two materials are coupled so that they are superimposed or adjacent, so that the graphic marking or numbering, produced by the laser beam, univocally characterizes the two materials and in particular their joining points, making them highly resistant to counterfeiting and duplication.

For example, FIG. 3 illustrates a banknote 50 featuring elements produced according to the inventive method to which the present invention relates. The banknote is characterized by a serial number 70 that is printed on its lower left side. A first layer of material 30 having high resistance to laser and a second layer composed of two materials 10 and 20 having different resistances are deposited on the lower right side. The serial number 70 is laser-scribed in this region as well, and covers at least two of the coupled materials, thus producing lines of writing of different width, with sudden changes in the points of contact between the coupled materials. The figure also illustrates by way of example, a silver-coated strip 55, on which the same serial number 70 is provided, and a logo 60, both of which are also scribed according to the described method.

It has been found that by using a laser apparatus having the characteristics described above by way of nonexclusive example it is possible to provide incremental numbering on a production line advancing at 150 m/min with a production rate of 10 alphanumeric characters with a height of 1 mm with a dynamic error of <0.1 mm in a time equal to 0.03 s (330 ch/s). The materials on which the laser beam can act are many and comprise, in particular, the materials used to produce distinctive security elements such as for example: products linked to the holographic system, such as optically variable devices (OVDs), diffractive optically variable image devices (DOVIDs), holograms, Pixelgrams, dot matrices, kinegrams, Gyrograms, Movigrams produced by embossing various materials such as acrylic or vinyl or nitrocellulose lacquers or metallic pigments desposited with the various printing or transfer techniques or metallized with a vacuum process and subjected to a subsequent vacuum metallization process with aluminium or copper or in any case with materials that are reflective and therefore reflect the holographic image;

inks marketed under the trademark OVI™ (optically variable inks) and printed, deposited or transferred;

inks of the color-shifting type, printed, deposited or transferred;

iridescent shifting inks, printed, deposited or transferred;

inks with magnetic properties, printed, deposited or transferred;

plastic and paper-like materials on which metal and/or oxides have been deposited, inserted, incorporated, printed or coupled in continuous or discontinuous form, even with infinitesimal thicknesses;

Security threads formed by one or more layers with widths from 0.3 to 1.0 mm, produced with metallic and/or magnetic and/or optical characteristics for example holographic ones, in continuous or discontinuous form or in any case with part of said materials present in any geometric form and applied, incorporated, inserted fully or partially in the paper substrate and/or plastic substrate;

strips with widths from 1 to 50 mm or in any case documents fully or partially made of plastic, produced with metallic and/or magnetic and/or optical characteristics, for example holographic ones, in continuous or discontinuous form or in any case with part of said materials present in any geometric form and applied, incorporated, inserted fully or partially in the paper substrate and/or plastic substrate;

security seals having various geometric shapes, for example with a diameter of approximately 1 mm to 50/60 mm, provided with metallic and/or magnetic and/or optical characteristics, for example holographic ones, in continuous or discontinuous form or in any case with part of said materials present in any geometric form and applied, embedded, inserted fully or partially in the paper substrate and/or plastic substrate.

It is evident that a customization system of this type has many fields of application and use. By way of example, a few macroareas in which the present invention is applied are presented, considering in particular the field of banknotes: in any banknote, the described method allows to provide a graphic marking and/or a numbering code produced by removing or changing the wavelength, in the visual spectrum and in the near-ultraviolet range or in the near-infrared range, metallic materials applied with a vacuum metallization technique, pigments and/or inks deposited with an intaglio printing and/or screen printing and/or typographic and/or lithographic method et cetera, with a hot transfer or self-adhesive method or otherwise applied in any way to the banknote. The graphic markings and the numbering codes can be produced with alphanumeric characters, optionally alternated with graphic markings provided in positive or negative form. The graphic markings and the numbering acquire greater value when they are provided on at least one of the distinct elements arranged so that they overlap or are mutually adjacent. It is straightforward to check the achieved congruousness, since in order to be able to forge or counterfeit such a graphic marking or numbering code the counterfeiter must have at his disposal not only the device used or scribing the materials, i.e. the laser, but also the individual components; the graphic markings and the numbering provided, in view of the width of the spot, become more secure as the extent of the parts of the pattern that cross the various deposited materials increases, thus significantly raising the level of security of a banknote. The provision of the invention can occur directly at the printing facility of the national banknote printing institute during the numbering of the banknote, even simultaneously with the conventional numbering step, since the laser device allows much higher operating speeds than current mechanical numbering devices. It is also evident that a system of this type can replace numbering performed in the conventional manner, i.e. fully replace mechanical numbering devices, with all the advantages of a laser-based numbering system over mechanical numbering. For example, by mounting six laser heads, one for each row of banknotes, one can obtain uncut sheets of banknotes to which holograms in positioned form or in continuous form are applied, said holograms bearing the same number as the banknote.

A second application of the inventive method according to the invention allows to provide a security thread that features a graphic marking, an inscription or a numbering provided by removing or changing the wavelength, in the visual spectrum or in the near-ultraviolet range or in the near-infrared range, of metallic materials applied with a conventional vacuum metallization method, pigments and/or inks deposited with a rotogravure, screen-printing, typograhic, lithographic, flexo technique, spread or otherwise printed even with a hot transfer or self-adhesive method or otherwise applied to provide a security thread. The security thread can be incorporated or inserted fully or partially in the paper substrate 50 or applied thereon. In this case also, the graphic markings and the numbering that are provided can be inserted by the thread manufacturer during the cutting of the thread or during rereeling.

A third application consists in providing a security strip, for example of the type featuring a graphic marking, an inscription or numbering provided by removing or changing the wavelength, in the visual spectrum or in the near-ultraviolet range or in the near-infrared range, of metallic materials applied with a vacuum metallization method, pigments and/or inks deposited with a rotogravure, screen-printing, flexo technique, spread or printed even with a hot transfer or self-adhesive method or otherwise applied to provide a security strip. In this case also, the graphic markings and the numbering codes can be provided by the ribbon manufacturer during the various steps of production.

Considering the field of documents in general, such as for example the field of checks, tickets, seals and security labels, in the case of checks one finds that the numbering provided according to the described method by removal or modification in an irreversible manner in the visual spectrum or in the near-ultraviolet or near-infrared range, particularly by intervention on at least two coupled materials, increases considerably the level of security against forgery of the document.

Similar considerations also apply to tickets, since it is virtually impossible to replace or modify the numbering or the code scribed recording to the described method, since the lettering must be modified by removing material by burning or sublimation and inserting new material. This operation is rendered even more difficult by the use of the above described materials, which are high-security products.

With this system, security seals and labels also can increase considerably their degree of security, since the method lends itself to be used together with systems of the tamper-evident type.

It has thus been shown that the present device achieves the proposed aim and objects. In particular, a method has been described that is capable of making it extremely difficult to forge and counterfeit value-bearing documents, particularly banknotes by treating known materials with a laser beam. Clearly, numerous modifications are evident and can be promptly applied by the person skilled in the art without abandoning the scope of the protection of the present invention. For example, it is clear that the type of material used can be any, so long as it is sensitive to laser, and that likewise the documents that can be characterized by virtue of the described method can be any.

Accordingly, the scope of the protection of the claims must not be limited by the illustrations or preferred embodiments presented in the description by way of example, but rather the claims must comprise all the characteristics of patentable novelty that can be deduced from the present invention, including all the characteristics that would be treated as equivalent by the person skilled in the art.

A method for customising security documents, particularly banknote, checks and documents representing a value in general. The method is suitable to prevent their forgery and alteration and comprises the steps that consist in superimposing at least two materials (10, 20) having different resistances to laser and being arranged adjacent to each other onto a substrate (30) having a higher resistance to laser than each of the superimposed materials (10, 20) and treating said superimposed materials (10, 20) with a laser beam which is guided along a preset path in order to modify by sublimation a part of each superimposed material (10, 20) by subjecting it to said laser beam without substantially burning or sublimating said substrate (30).

1.-23. (canceled).

24. A method for protecting against counterfeiting and forgery of a document, comprising the steps of:
superimposing at least two materials onto a substrate of the document, each of the at least two materials having different resistances to a laser, wherein the substrate has a higher resistance to the laser than each of the at least two materials, and each of the at least two materials are arranged adjacent to another of the at least two materials; and
emitting a laser beam and subjecting the at least two superimposed materials to the laser beam by guiding the laser beam along a preset path to modify by sublimation a part of each of the at least two superimposed materials without substantially burning or sublimating the substrate.

25. The method of claim 24, wherein one of the at least two superimposed materials is a holographic device comprising one of an Optically Variable Device (OVD), a Diffractive Optically Image Device (DOVID), a hologram, a pixelgram, a dot matrix, a kinegram, a gyrogram, and a movigram, the holographic device being produced by one of embossing various materials including at least one of acrylic, vinyl, and nitrocellulose lacquers, depositing metallic pigments using printing or transfer techniques, and metallizing using a vacuum process and subjecting the holographic device to a subsequent vacuum metallization process with aluminium or copper or a material that is reflective to reflect a holographic image.

26. The method of claim 24, wherein one of the at least two superimposed materials is an ink printed, deposited, or transferred onto the substrate, the ink being selected from the group consisting of an ink marketed under the trademark OVI™ (Optically Variable Ink), an ink of the color-shifting type, an iridescent shifting ink, and an ink with magnetic properties.

27. The method of claim 24, wherein the substrate is one of a paper-like material and a plastic material, and wherein one of the at least two superimposed materials includes at least one of metal and oxides deposited on, inserted on, incorporated on, printed on or coupled with the substrate in continuous or discontinuous form.

28. The method of claim 27, wherein the at least one of metal and oxides is applied in an infinitesimal thickness.

29. The method of claim 24, wherein one of the at least two superimposed materials is a security thread comprising one or more layers with a width from 0.3 to 1.0 mm, the security thread comprising at least one of metallic, magnetic, and optical characteristics, and the security thread being in continuous or discontinuous form.

30. The method of claim 24, wherein one of the at least two superimposed materials is a strip having a width from 1 to 50 mm and comprising plastic, the strip having at least one of metallic, magnetic, and optical characteristics, and the strip being in continuous or discontinuous form.

31. The method of claim 24, wherein one of the at least two superimposed materials is a security seal with a diameter of approximately 1 mm to 50/60 mm, the security seal having at least one of metallic, magnetic, and optical characteristics, the security seal being in continuous or discontinuous form.

32. The method of claim 24, wherein the substrate comprises at least one of paper and plastic and wherein a part of one of the at least two materials is present in any geometric form and applied, incorporated, or inserted fully or partially in the substrate.

33. The method of claim 24, wherein said step of emitting the laser beams comprises emitting the laser beam with a substantially constant energy.

34. The method of claim 24, wherein the preset path passes through at least one point of contact between the at least two superimposed materials.

35. The method of claim 24, wherein the preset path forms at least one of an alphanumeric symbol and a graphic symbol.

36. The method of claim 24, wherein the document is selected from the group of documents consisting of banknotes, checks, tickets, cards, identity documents, and security labels.

37. The method of claim 24, wherein said step of superimposing includes superimposing three materials onto the substrate of the document, wherein each of the three materials has different resistances to the laser, the substrate has a higher resistance to the laser than each of the three materials, and the three materials are arranged adjacent to each other on the substrate.

38. A document having security features for protection against forgery and counterfeiting, comprising:
a substrate; and
at least two materials having different resistances to a laser, said at least two materials being superimposed onto said substrate such that each of said at least two materials are arranged adjacent to another of said at least two materials, said substrate having a higher resistance to the laser than each of said at least two superimposed materials;
a scribing formed in each of said at least two superimposed materials by a laser beam of the laser guided along a preset path such that portions in each of said at least two superimposed materials are sublimated by the laser beam without substantially burning or sublimating the substrate.

39. The document of claim 38, wherein one of said at least two superimposed materials is a holographic device comprising one of an Optically Variable Device (OVD), a Diffractive Optically Image Device (DOVID), a hologram, a pixelgram, a dot matrix, a kinegram, a gyrogram, and a movigram, said holographic device being produced by one of embossing various materials including at least one of acrylic, vinyl, and nitrocellulose lacquers, depositing metallic pigments using printing or transfer techniques, and metallizing using a vacuum process and subjecting the holographic device to a subsequent vacuum metallization process with aluminium or copper or a material that is reflective to reflect a holographic image.

40. The document claim 38, wherein one of said at least two superimposed materials is an ink printed, deposited, or transferred onto the substrate, the ink being selected from the group consisting of an ink marketed under the trademark OVI™ (Optically Variable Ink), an ink of the color-shifting type, an iridescent shifting ink, and an ink with magnetic properties.

41. The document of claim 38, wherein said substrate is one of a paper-like material and a plastic material, and wherein one of said at least two superimposed materials includes at least one of metal and oxides deposited on, inserted on, incorporated on, printed on or coupled with the substrate in continuous or discontinuous form.

42. The document of claim 41, wherein said at least one of metal and oxides is applied in an infinitesimal thickness.

43. The document of claim 38, wherein one of said at least two superimposed materials is a security thread comprising one or more layers with a width from 0.3 to 1.0 mm, said security thread comprising at least one of metallic, magnetic, and optical characteristics, and said security thread being in continuous or discontinuous form.

44. The document of claim 38, wherein one of said at least two superimposed materials is a strip having a width from 1 to 50 mm and comprising plastic, said strip having at least one of metallic, magnetic, and optical characteristics, and said strip being in continuous or discontinuous form.

45. The document of claim 38, wherein one of said at least two superimposed materials is a security seal with a diameter of approximately 1 mm to 50/60 mm, said security seal having at least one of metallic, magnetic, and optical characteristics, said security seal being in continuous or discontinuous form.

46. The document of claim 38, wherein the substrate comprises at least one of paper and plastic and wherein a part of one of the at least two materials is present in any geometric form and applied, incorporated, or inserted fully or partially in said substrate.

47. The document of claim 38, wherein said scribing is formed by the laser beam emitting a substantially constant energy.

48. The document of claim 38, wherein said scribing represents at least one of an alphanumeric symbol and a graphic symbol.

49. The document of claim 38, wherein said document is one of a banknote, a check, a ticket, a card, an identity document, and a security label.

50. The document of claim 38, wherein said at least two materials comprise three materials having different resistances to the laser, said three materials being arranged so that each of said three materials is adjacent to at least another of said three materials, said substrate having a higher resistance to the laser than each of said three materials, and said three materials being superimposed onto said substrate.
